(19) United States
(12) Patent Application Publication
(10) Pub. No.: US 2025/0014152 A1
(43) Pub. Date: Jan. 9, 2025

(54) SYSTEMS AND METHODS FOR DENOISING IMAGE DATA

(71) Applicant: Gauss Labs Inc., Palo Alto, CA (US)

(72) Inventors: Yonghyun Kim, Seongnam-si (KR); Ilkoo Kim, Seongnam-si (KR); Sang-gil Park, Seoul (KR)

(21) Appl. No.: 18/756,283

(22) Filed: Jun. 27, 2024

Related U.S. Application Data
(60) Provisional application No. 63/589,741, filed on Oct. 12, 2023.
(60) Provisional application No. 63/512,531, filed on Jul. 7, 2023.

(51) Int. Cl. G06T 5/70

(52) U.S. Cl. CPC G06T 5/70; G06T 2207/10061; G06T 2207/30148; G06T 2207/30168

(57) ABSTRACT

Systems and methods for utilizing a universal denoiser for improving Ebeam images are disclosed. A method can include obtaining a base set of Ebeam images from a plurality of domains within a process environment; and applying a universal denoiser to the base set of Ebeam images to generate an enhanced set of Ebeam images, wherein the enhanced set of Ebeam images has a higher quality than the base set of Ebeam images and accounts for a domain type of each of the plurality of domains.

### CROSS-REFERENCE TO RELATED APPLICATIONS

This application claims the benefit of U.S. Provisional Application No. 63/512,531, filed Jul. 7, 2023, and U.S. Provisional Application No. 63/589,741, filed Oct. 12, 2023, each of which is incorporated by reference herein in its entirety.

### BACKGROUND

In manufacturing semiconductor chips, producing a single wafer can involve numerous processes, measurements, and resources over an extended period of time. Thus, the semiconductor industry strives to reduce this production time, and the demand for more precise and faster measurements has been consistent. In the case of semiconductor measurements associated with Electron Beam (Ebeam) processes, multiple images can be combined at the equipment level to produce a single high-quality image with reduced noise to counteract the various noise generated during the image acquisition process. However, this process can consume a significant amount of time and resources. Another challenge is dealing with images from different domains or domain types that are vastly different from each other.

### SUMMARY

Disclosed herein is a universal denoiser architecture for generating high-quality Ebeam images from low-quality images across multiple domains and domain types for improving and enabling accurate high-throughput metrology. Measuring a critical dimension (CD), which may include width and length of a specific object or features, from images captured using Ebeam equipment can be important in various industrial sectors. Likewise, the semiconductor industry is a field that actively utilizes such Ebeam images. In the semiconductor industry, producing a single wafer involves numerous processes, measurements, and resources over an extended period of time. Thus, the semiconductor industry strives to reduce this production time, which results in an unmet need for more precise and faster measurements. In the case of semiconductor measurements using Ebeam processes, multiple images are combined at the equipment level to produce a single high-quality image with reduced noise to counteract the various noise generated during the image acquisition process. Noise can result from different domains and domain types associated with Ebeam processes. However, reducing noise in Ebeam images consumes significant time, which poses an unsolved technical problem. Another technical challenge can be dealing with Ebeam images that are vastly different from each other due to, e.g., different domains and domain types. Disclosed herein is a universal architecture that utilizes a universal denoiser technical solution that can solve at least the above and other technical challenges, and that can be used effectively across multiple domains and domain types to reduce noise in Ebeam images.

The universal denoiser architecture disclosed herein can generate an enhanced high-quality or high-framed image using low-quality or low-framed images. The universal denoiser includes a learned conditioning scheme that is configured to generate the high-quality or high-framed image. Compared to typical approaches, the universal denoiser disclosed herein can extend beyond simply matching the average shape of the images. The universal denoiser can include a unique universal design and learning method to be effective across various domains or domain types, while ensuring that object measurements (e.g., CD measurements) are identical or substantially identical to CDs of high-quality images. The disclosed universal denoiser architecture includes a unique network structure based on conditions to handle various domains or domain types within a single universal architecture. Each component of the disclosed architecture can be utilized to take into account the principles of Ebeam image creation and measurement methods. Further, the universal denoiser can utilize loss functions to accommodate metrology purposes for training the disclosed universal architecture.

The present disclosure can significantly contribute to manufacturing process productivity by quickly generating high-quality, stable metrology images from fewer and low-quality images. Furthermore, the universal denoiser has been implemented and validated through volume tests. The volume tests (e.g., a variety of images are taken and verified for actual wafers) confirmed that the determined CD values were identical or substantially identical for SEM images in the semiconductor field.

In an aspect, disclosed herein is a method of enhancing electron-beam (Ebeam) images, comprising: obtaining a base set of Ebeam images from a plurality of domains within a process environment; and applying a universal denoiser to the base set of Ebeam images to generate an enhanced set of Ebeam images, wherein the enhanced set of Ebeam images has a higher quality than the base set of Ebeam images and accounts for a domain type of each of the plurality of domains.

In some embodiments, the process environment may comprise a semiconductor manufacturing environment.

In some embodiments, the method further comprises: using the enhanced set of Ebeam images for metrology within the process environment.

In some embodiments, the metrology comprises a measurement of one or more critical dimensions (CDs) in an intermediate output device or a final output device of the process environment.

In some embodiments, the intermediate output device or the final output device of the process environment comprises a deposited or fabricated structure.

In some embodiments, the deposited or fabricated structure comprises a film, a layer, or a substrate.

In some embodiments, the universal denoiser maintains a same set of measurands in the metrology across the plurality of domains within the process environment.

In some embodiments, the enhanced set of Ebeam images comprises a greater number of frames than the base set of Ebeam images.

In some embodiments, the greater number of frames is at least about 5%, 10%, 15%, or greater than the number of frames of the base set of Ebeam images.

In some embodiments, the higher quality of the enhanced set of Ebeam images is based at least in part on the greater number of frames.

In some embodiments, the base set of Ebeam images comprises a limited or low number of frames.

In some embodiments, the limited or low number of frames is at least about 15%, 10%, 5%, or lower than the enhanced set of Ebeam images.

In some embodiments, the plurality of domains are associated with a plurality of processing steps and/or equipment in the process environment.

In some embodiments, the plurality of domains are associated with a plurality of Ebeam equipment.

In some embodiments, the domain type for each of the plurality of domains is associated with a type of Ebeam equipment.

In some embodiments, the type of Ebeam equipment comprises a transmission electron microscope (TEM), a scanning electron microscope (SEM), a reflection electron microscope (REM) lithography system, an electron beam inspection system, a focused ion beam system, or any derivatives or combinations thereof.

In some embodiments, the universal denoiser compensates for a range of noise types in the base set of Ebeam images and/or the enhanced set of EBeam images using at least in part a conditioning scheme, wherein the range of noise types is attributable to operating differences across the plurality of domains within the process environment.

In some embodiments, the domain type for each of the plurality of domains comprises one or more conditions associated with Ebeam generation for each of the plurality of domains.

In some embodiments, the one or more conditions comprise camera types and image capture parameters.

In some embodiments, the image capture parameters comprise image capture resolution and/or frame rate.

In some embodiments, the one or more conditions associated with the Ebeam generation for each of the plurality of domains, are encoded into an image condition vector for each of the plurality of domains.

In some embodiments, the image condition vector for each of the plurality of domains is associated with a base subset of Ebeam images from each of the plurality of domains.

In some embodiments, the universal denoiser uses a plurality of loss functions to reduce differences in the metrology at a global level and to focus the metrology at a local feature level for the measurement of the one or more CDs.

In some embodiments, the plurality of loss functions is selected from the group consisting of metrology-aware marginal intensity loss (MMIL), noise level loss (NLL), threshold loss (THL), and block variance loss (BVL).

In another aspect, disclosed herein is a network architecture for use in a universal denoiser system to enhance electron-beam (Ebeam) images, the network architecture comprising: a condition network configured to calculate a plurality of values using a condition embedding: a conditioned ResBlock configured to utilize at least some of the values to adjust an intermediate response map based at least in part on importance of the values; and a conditioned affine layer configured to (1) enable learning of EBeam image synthesis logic and (2) allow for application of different conditions to separately learn a suitable recipe for a particular EBeam process.

In some embodiments, the plurality of values calculated by the condition network include alpha, beta, or gamma values, or combinations thereof.

In some embodiments, the condition embedding is converted through a condition table.

In some embodiments, the condition table is configured to convert input in a form of recipe metadata into the condition embedding.

In some embodiments, the recipe metadata includes numerical and categorical conditions.

In some embodiments, the condition table comprises an embedding table configured to embed the categorical conditions.

In some embodiments, the at least some of the values utilized by the conditioned ResBlock include the beta and the gamma values.

In some embodiments, the conditioned ResBlock comprises a conditioning block configured to adjust the intermediate response map by applying the beta and gamma values.

In some embodiments, the intermediate response map is adjusted to emphasize or weaken one or more channels, based at least in part on a relevance of each of the one or more channels to the particular EBeam process.

In some embodiments, the embedding table is learned via a training process using the conditioned affine layer.

In some embodiments, the embedding of the categorical conditions is optimized to more accurately capture unique characteristics of input data, with progression in the learning of the embedding table.

In some embodiments, the condition network is configured to effectively adjust features based at least in part on the recipe metadata and the conditioned affine layer, thereby enabling improvements in accuracy and precision in the enhanced set of Ebeam images.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the present disclosure contained in the specification, the specification is intended to supersede and/or take precedence over any such contradictory material.

### BRIEF DESCRIPTION OF THE DRAWINGS

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a conventional approach of using a single model (e.g., a single denoiser) to handle all data (e.g., Ebeam images) and does not distinguish (or is not capable of distinguishing) between different domains or domain types;

FIG. 1B shows a conventional approach of using multiple models (e.g., multiple denoisers) that are specific to each domain or domain type;

FIG. 1C shows an exemplary universal denoiser that is capable of maintaining metrology precision and handling data from multiple or different domains, in accordance with some embodiments;

FIG. 2 shows an exemplary architecture of the universal denoiser, in accordance with some embodiments;

FIG. 2A shows an exemplary diagram of a conditioned ResBlock of the exemplary architecture of FIG. 2, in accordance with some embodiments;

FIG. 2B shows an exemplary conditioning block, in accordance with some embodiments;

FIG. 3 shows an exemplary condition table, in accordance with some embodiments;

FIG. 4 shows an exemplary architecture of the universal denoiser using a set of keys to identify a set of conditions, in accordance with some embodiments;

FIG. 5 shows a non-limiting example of a computing system, in accordance with some embodiments;

FIG. 6 shows a non-limiting example of a web/mobile application provision system, in accordance with some embodiments; and

FIG. 7 shows a non-limiting example of a cloud-based web/mobile application provision system, in accordance with some embodiments.

### DETAILED DESCRIPTION

While various embodiments of the present disclosure have been shown and described herein, such embodiments are provided by way of example only. Numerous variations, changes, or substitutions may occur without departing from the present disclosure. It should be understood that various alternatives to the embodiments of the present disclosure described herein may be employed.

Disclosed herein are systems and methods for a universal denoiser for Ebeam image-based measurements. The systems and methods disclosed herein can provide a universal denoising architecture/framework that is capable of reducing a diverse range of noise types across various images that may result from different domains or domain types. The disclosed systems and methods can incorporate the principles of Ebeam image generation and measurement methodologies within a network structure and learning scheme.

### Universal Denoiser and Methods

In an aspect, disclosed herein is a method of enhancing electron-beam (Ebeam) images, comprising: obtaining a base set of Ebeam images from a plurality of domains within a process environment; and applying a universal denoiser to the base set of Ebeam images to generate an enhanced set of Ebeam images, wherein the enhanced set of Ebeam images has a higher quality than the base set of Ebeam images and accounts for a domain type of each of the plurality of domains. In some cases, the plurality of domains may comprise at least about 5, 10, 50, 100, or more domains. In some cases, the plurality of domains may comprise at most about 100, 50, 10, 5, or less domains. In some cases, the universal denoiser can account for the domain or domain type by processing or utilizing data or information associated with each domain or domain type to generate the enhanced set of Ebeam images, e.g., camera type and conditions or parameters associated with each camera type, to generate the enhanced set of Ebeam images. In some cases, the higher quality of the enhanced set of Ebeam images can include a higher resolution or a greater number of frames than the base set of Ebeam images. In some cases, the process environment can include an electronics manufacturing process, e.g., an electronics manufacturing environment (e.g., semiconductors or batteries), an aerospace and defense manufacturing environment (e.g., satellites, unmanned systems, or manned systems), a consumer electronics manufacturing environment (e.g., smartphones or computers), an industrial manufacturing environment (e.g., robotics or automation), or a health care manufacturing environment (e.g., medical devices). In some embodiments, the process environment may comprise a semiconductor manufacturing environment.

### Improving Metrology

In some embodiments, the method further comprises using the enhanced set of Ebeam images for metrology within the process environment. In some embodiments, the metrology comprises a measurement of one or more critical dimensions (CDs) in an intermediate output device or a final output device of the process environment. For example, the device may be a wafer. For example, CDs can include width, height, shape, topographic features, line edge roughness, or volume of an object or feature associated with a wafer of a semiconductor process. The wafer may be obtained at an intermediate step of the semiconductor process to determine one or more metrology measurements from Ebeam images. The Ebeam images can be obtained from, e.g., a transmission electron microscope (TEM), a scanning electron microscope (SEM), a reflection electron microscope (REM) lithography system, an electron beam inspection system, a focused ion beam system, or any derivatives or combinations thereof. In some embodiments, the intermediate output device or the final output device of the process environment comprises a deposited or fabricated structure. In some embodiments, the deposited or fabricated structure comprises a film, a layer, or a substrate. The one or more metrology measurements can assist in determining changes or improvements to the semiconductor process.

Additionally or alternatively, the wafer may be obtained after a final step of the semiconductor process to determine one or more metrology measurements. The one or more measurements can also assist in determining changes or improvements to the semiconductor process. In some embodiments, the universal denoiser maintains a same set of measurands in the metrology across the plurality of domains within the process environment. For example, measurands can include CDs such as width, height, shape, topographic features, line edge roughness, or volume of an object or feature associated with a wafer of a semiconductor process. In some cases, a measurand can be directly measured by metrology, e.g., a width of an object or feature. In some cases, a measurand can be derived from metrology, e.g., a volume that is derived from a width, length, and height of an object or feature.

In some embodiments, a universal denoiser scheme may be applied to a diverse range of noise types across various images through a conditioning scheme. For example, noise types or severity of noise can vary due to images obtained from different domains or domain types. In SEM, for example, types of noise can be due to inherent characteristics of the SEM. Noise can include primary emission noise, secondary emission noise, scintillator noise, photocathode noise, photomultiplier noise, or thermionic noise. Types of noise can also be due to sources external to the SEM. Noise can include electromagnetic noise (e.g., electrical characteristics of the domain in which the SEM is installed), thermal noise (e.g., thermal characteristics such as temperature of the domain in which the SEM is installed), or mechanical noise (e.g., mechanical characteristics such as vibrations of the domain in which the SEM is installed). The noise can affect the signal-to-noise ratio (SNR), spatial resolution, and signal amplitude of an image and reduce the accuracy or precision of metrology. Based on least on the noise that results from a domain or domain type, the conditioning scheme, described elsewhere herein, can adjust values utilized in activation maps and image statistics of each layer of an image in a backend image recognition network. The generated or learned values utilized by the condition scheme may vary depending on the properties or conditions of the image analyzed by the universal denoiser. Properties or conditions can include or be associated with settings used during generation of Ebeam images, e.g., camera types and image capture parameters such as resolution or frame rate. In some cases, settings can include SEM modes such as resolution mode, high-current mode, depth-of-focus mode, or low-voltage mode. In some cases, settings can be associated with resolution, frame rate, brightness, contrast, magnification, depth of field, bias voltage, scan time, or orientation.

Preserving Feature Scale Size from Metrology

Also disclosed are network architectures for a universal denoiser that can accurately represent the unique local characteristics of objects in Ebeam images. In some embodiments, the universal denoiser can preserve feature scale size between the base set of Ebeam images and the enhanced set of Ebeam images using a network architecture. For example, the network architectures disclosed herein can preserve an object's feature scale size from input to output of a semiconductor process while minimizing the number of channels. The network architectures may be configured to use a convolutional neural network (CNN). The CNN may contain a plurality of layers that increases the number of channels or extracted features as an image is processed by each layer. Increasing the number of channels or extracted features can require additional resources. e.g., computing resources and computing time which can increase production time. Conventional networks my reduce the feature scale size to bring computing resources to manageable levels. However, reducing feature scale size can unacceptably reduce accuracy or precision in metrology. In some embodiments, the feature scale size is preserved while minimizing a number of channels used to generate the enhanced set of Ebeam images. This is in contrast to conventional networks that increase the number of channels while reducing the feature scale. In some cases, the network architecture does not require increasing a number of channels to generate the enhanced set of Ebeam images. In some embodiments, the network architecture does not reduce a feature scale size in generating the enhanced set of Ebeam images. The present disclosure can provide greater accuracy or precision for metrology measurements in semiconductor processes, which typically require high accuracy or high precision measurements by analyzing local features. Compared to the present disclosure, conventional approaches may instead consider the context of the whole or part may, which can result in small differences that affect metrology accuracy or precision.

Moreover, the universal denoiser can include one or more loss functions, described elsewhere herein, specifically designed to preserve object features in metrology processes. The loss functions of the present disclosure can reduce differences in metrology processes, in contrast to conventional approaches that may focus on differences between images. The loss functions disclosed herein can enable the learning of the distribution of image blocks, noise levels, or other metrology aspects, which can support obtaining similar visual characteristics and more accurate metrology measurements.

The disclosed universal denoiser architecture differs from conventional methods, as the universal denoiser aims to generate high-quality Ebeam images while maintaining the same measurands in metrology. In contrast, conventional methods focus on ensuring that a given image is similar to the ground truth image in an average manner, which could lead to inaccurate or unstable values of measurands.

### Processing Different Domains and Domain Types

In some embodiments, the plurality of domains are associated with a plurality of processing steps and/or equipment in the process environment. For example, processing steps may include steps for depositing a structure or object on a wafer. Processes may include thin film chemical deposition (e.g., chemical vapor deposition (CVD)), thin film physical vapor deposition (vacuum thermal evaporation, sputter deposition, magnetron sputtering deposition), electron beam deposition/evaporation, and the like.

In some embodiments, the plurality of domains are associated with a plurality of Ebeam equipment. For example. Ebeam equipment or instruments can include equipment or instruments configured to inspect wafers using a high-energy electron beam to generate images that can be analyzed for flaws or mechanical deficiencies. In some embodiments, the domain type for each of the plurality of domains is associated with a type of Ebeam equipment. In some embodiments, the type of Ebeam equipment comprises a transmission electron microscope (TEM), a scanning electron microscope (SEM), a reflection electron microscope (REM) lithography system, an electron beam inspection system, a focused ion beam system, or any derivatives or combinations thereof.

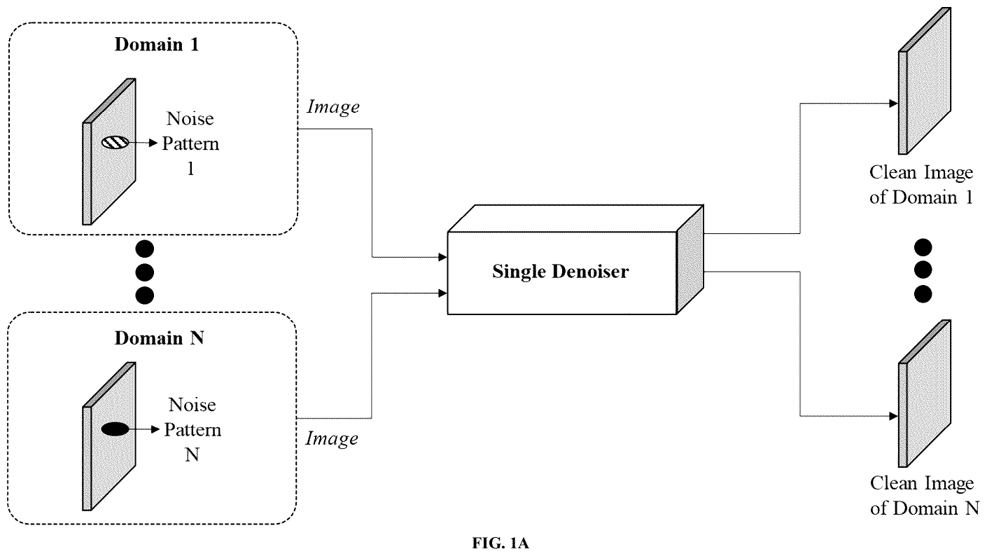

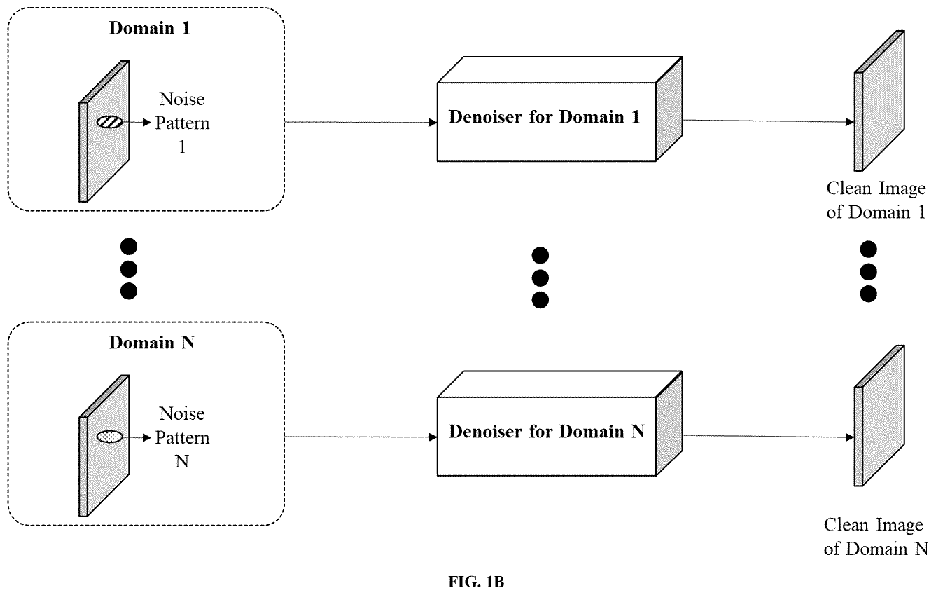

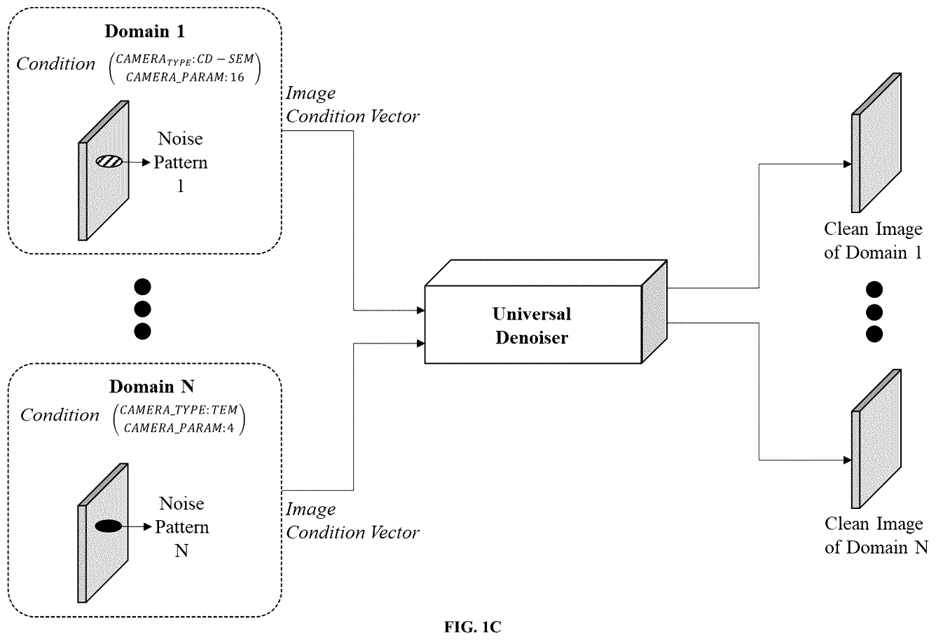

FIG. 1A shows a conventional approach of using a single model (e.g., a single denoiser) to handle all data (e.g., Ebeam images) and does not distinguish between different domains or domain types, and FIG. 1B shows a typical approach of using multiple models (e.g., multiple denoisers) specific to each domain or domain type. These two approaches are typically used when a vast amount of data (e.g., Ebeam images) is available or sub-pixel level accuracy is not required. However, in situations demanding precise or accurate metrology, such as in semiconductor metrology or in manufacturing processes where data may be scarce (e.g., few images), these methods often cannot be used.

Compared to conventional approaches shown in FIGS. 1A-1B, the universal denoiser architecture/framework of FIG. 1C can maintain metrology precision or accuracy while handling data from multiple domains or domain types. This can be achieved by collecting conditions (e.g., camera types and image capture parameters) related to image generation across different domains or domain types (e.g., types of Ebeam equipment in different processing domains or environments) and utilizing or analyzing them together. Accounting for conditions in Ebeam image-based measurements can solve technical challenges in diverse fields, particularly where precision or accuracy is important and when sufficient data may not be available.

### Learning Conditioning Schemes

In some embodiments, the universal denoiser compensates for a range of noise types in the base set of Ebeam images and/or the enhanced set of EBeam images using at least in part a conditioning scheme. In some cases, the range of noise types is attributable to operating differences across the plurality of domains within the process environment. In some embodiments, the domain type for each of the plurality of domains comprises one or more conditions associated with Ebeam generation for each of the plurality of domains. In some embodiments, the one or more conditions comprise camera types and image capture parameters. For example, as illustrated in FIG. 1C, domain 1 may include Ebeam images obtained from an SEM domain type. The SEM may include conditions, parameters, or settings used during the obtaining of the Ebeam images (e.g., camera_param: 16). Another domain may include Ebeam images obtained from a TEM domain type. The TEM may include conditions, parameters, or settings used during the obtaining of the Ebeam images (e.g., camera_param: 4). For example, a parameter can include image capture resolution or frame rate. In some embodiments, the image capture parameters comprise image capture resolution and/or frame rate.

In some embodiments, the one or more conditions associated with the Ebeam generation for each of the plurality of domains, are encoded into an image condition vector for each of the plurality of domains. In some embodiments, the image condition vector for each of the plurality of domains is associated with a base subset of Ebeam images from each of the plurality of domains.

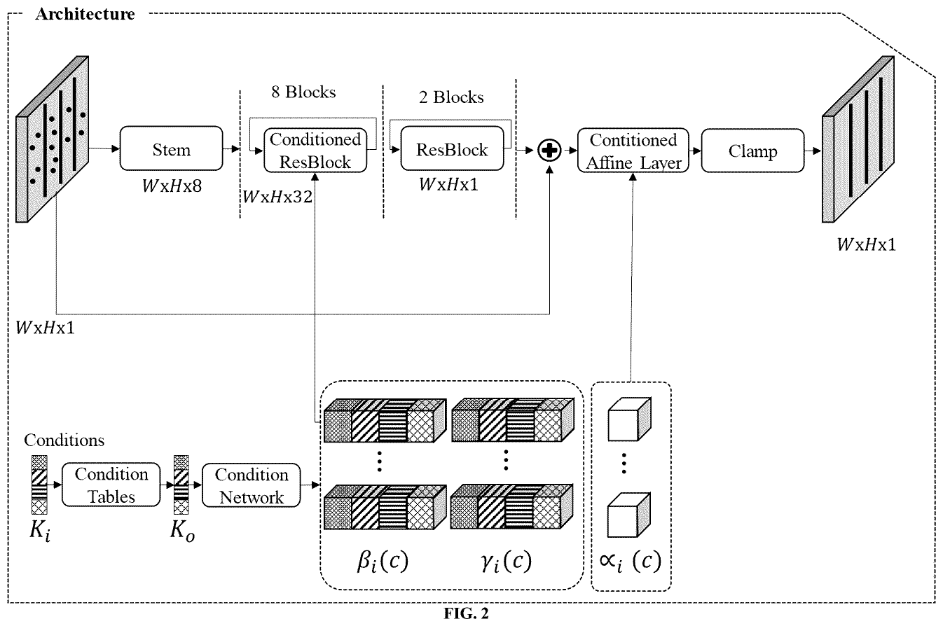

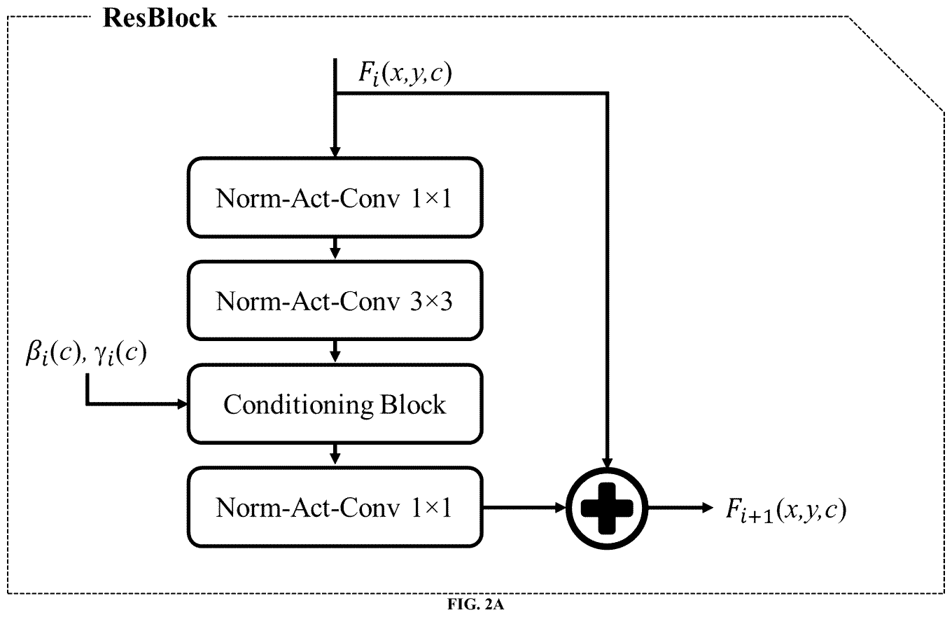

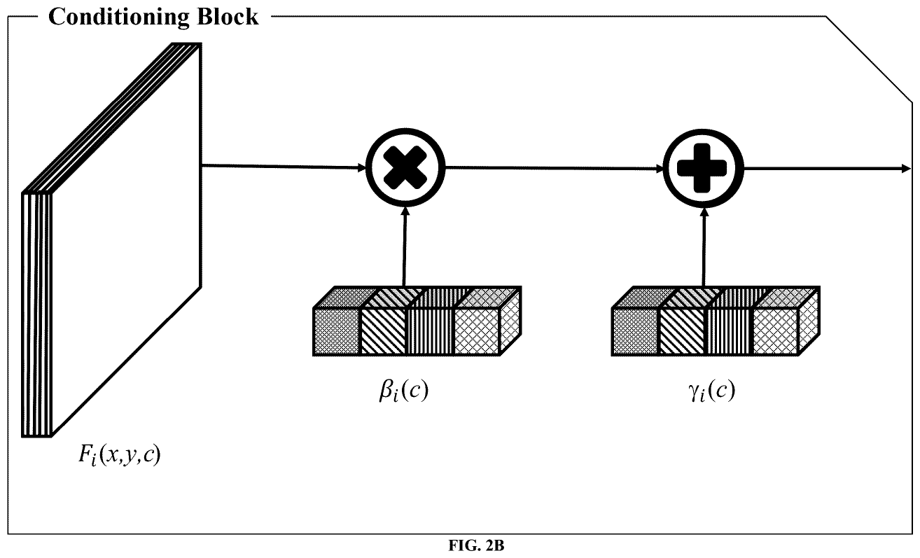

FIG. 2 shows an exemplary architecture of the universal denoiser for generating and processing images and associated image condition vectors to reduce noise in Ebeam images, in accordance with some embodiments. To reduce noise in Ebeam images, the disclosed network architecture utilizes several unique features, including the condition network, conditioned ResBlock and/or conditioned affine layer. The learned condition network can calculate values such as alpha, beta, and gamma from Ebeam images using the condition embedding that is converted through the condition tables. The conditioned ResBlock utilizes these beta and gamma values to adjust the intermediate response map values based on their importance. Furthermore, the conditioned affine layer can enable the learning of Ebeam image synthesis logic and allow for the application of different conditions to separately learn a suitable method or process for each recipe. These distinctive components can contribute to the effectiveness and versatility of the disclosed network architecture and provide a more sophisticated and tailored approach to generate high-quality Ebeam images.

FIG. 2A shows an exemplary diagram of the conditioned ResBlock of the example architecture of FIG. 2, in accordance with some embodiments. In an example, the architecture may denoise Ebeam images with a number of channels (n) of pixel size width (W) by height (H) (W×H×n), which are the base set of Ebeam images, to generate fewer than the base set of Ebeam images, which is the enhanced set of Ebeam image. Conditions, e.g., camera type and parameters, may be associated with each of the images to include in the condition tables and condition network. The condition network may generate beta (βᵢ) or gamma (γᵢ) values from each image. The condition network may determine a new set of beta (βᵢ) and gamma (γᵢ) values for the conditioned ResBlock to use for generating the enhanced Ebeam image. Beta (βᵢ) values generally mean values associated with bias or brightness of an image. Gamma (γᵢ) values generally mean values associated with correcting for nonlinear response in an image. Alpha (αᵢ) values generally mean values associated with gain or contrast of an image.

The conditioned ResBlock may receive as input the feature or intermediate response map, Fᵢ(x, y, c). The conditioned ResBlock may include a conditioning block that receives as input the beta (βᵢ) and gamma (γᵢ) values obtained through the condition network. The conditioning block may adjust the feature or intermediate response map. Fᵢ(x, y, c), based at least in part on the beta (βᵢ) and gamma (γᵢ) values to transform the feature or intermediate response map to another feature or response map, Fᵢ₊₁(x, y, c). The conditioned ResBlock comprising the conditioning black may use convolutional operations (e.g., Norm-Act-Con 1×1, 3×3, etc.) to transform the feature or intermediate response map based on at least on the beta (βᵢ) and gamma (γᵢ) values. FIG. 2B shows an exemplary conditioning block, in accordance with some embodiments. The convolutional operations can include an element wise multiplication (X) and summation (+) of the feature or intermediate response map and the filter. Through this conditioning process, the intermediate response map is modified or transformed to emphasize or weaken the channels or extracted features that are most relevant to the given Ebeam domain or domain type. This can enhance the accuracy and precision of Ebeam metrology by tailoring the network's features to the specific characteristics of the given input data (e.g., Ebeam images and associated metadata).

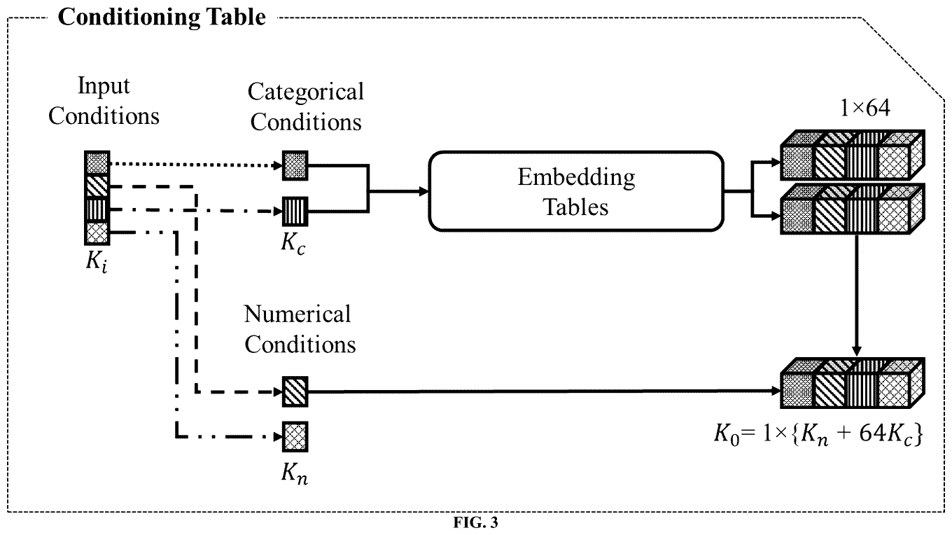

FIG. 3 shows an exemplary condition table, in accordance with some embodiments. The condition table may convert input in the form of recipe meta-information into condition embedding, which is used to adjust the network's feature or response map. The meta-information can include both numerical and categorical conditions and may be provided by a user (e.g., an engineer that is developing, monitoring, or using a process). To handle categorical conditions, an embedding table may be employed, which may be learned during the training process. As the learning progresses, the embedding of categorical conditions is optimized to more precisely capture the unique characteristics of the given input data. This conditioning scheme enables the network to effectively adjust its features based on the specific recipe meta-information, leading to improved accuracy and precision in generated Ebeam images.

### Utilizing Loss Functions

In some embodiments, the universal denoiser uses a plurality of loss functions to reduce differences in the metrology at a global level and to focus the metrology at a local feature level for the measurement of the one or more CDs. For example, metrology at a global level can include wafer-level metrology, e.g., statistical determinations of measurements of all objects or features on a wafer. Local feature level metrology can include measurements of objects or features located on the wafer, e.g., a width of an object or feature. In some embodiments, the plurality of loss functions is selected from the group consisting of metrology-aware marginal intensity loss (MMIL), noise level loss (NLL), threshold loss (THL), and block variance loss (BVL).

Metrology-aware Marginal Intensity Loss (MMIL). The MMIL function is a loss function that utilizes the L1 loss and is tailored to capture the unique scanning characteristics of Ebeam equipment (e.g., an SEM). In SEM metrology, the measurand is computed by generating a horizontal profile, making line-wise profile matching crucial for accurate measurements. Moreover, the SEM device creates an image through a line scan process where each pixel is processed sequentially from left to right, line by line. This scanning process creates a stronger relationship in the horizontal direction than in the vertical direction. Therefore, the MMIL function is defined as follows:

$${L}_{MMIL} ( x , y ) = \frac{1}{N} {\sum }_{i} max ( 0 , {‖ x - y ‖}^{2} - M ( {‖ x - y ‖}^{2} ) ) \qquad ( 1 )$$

where Mₕ(x) is a median value along the horizontal axis in the 2D image coordinate. By prioritizing the reduction of significant differences, MMIL disregards minor errors, x=[x₁, . . . , x_{N}] and y=[y₁, . . . , y_{N}].

Noise Level Loss (NLL). The impact of noise level on metrology can significantly reduce precision or accuracy in metrology. To quantify the noise level in an image, the average difference between the given image and a smoothed input image is calculated as follows:

$${L}_{1} ( x , y ) = {‖ N ( x ) - N ( y ) ‖}_{1} , \qquad ( 2 )$$

$$N ( x ) = \frac{1}{N} {\sum }_{i} {‖ {g}_{n} {x}_{i} ‖}_{1} ,$$

$${g}_{n} ( x ) = \times - smooth ( \times ; {θ}_{s} )$$

The function N(x) calculates the average difference between the input image x and a smoothed version of the image x, denoted as gₙ (x), over a total of N pixels. The smoothing operation is performed using a parameterized kernel function with a smoothing parameter θₛ. Finally, the L₁ norm of the difference between N(x) and N(y) is computed to obtain the NLL value.

Threshold Loss (THL). The THL function is tailored to the unique characteristics of metrology. Rather than focusing on making the denoised image identical to the ground truth image, the THL function aims to make the measurand of the denoised image identical to that of the ground truth image as follows:

$${L}_{THL} ( x , y ) = \frac{1}{{N}_{b}} {\sum }_{j} {‖ th ( {x}^{j} ) - th ( {y}^{j} ) ‖}_{1} \qquad ( 3 )$$

where a threshold function, thrs(x)=max(x)−min(x), which emulates the threshold method utilized in SEM metrology. To define a sampled vector x^{j}, samples from within a specific range of a horizontal profile line with an overlap are extracted. The threshold method is used to determine the middle point of a target peak by measuring the width of a given structure using the minimum and maximum values within a defined range over a line profile.

Block Variance Loss (BVL). The BVL function is another aspect that reflects the unique characteristics of metrology. In addition to the threshold method used in the THL function. BVL function utilizes contextual statistics in block units. Specifically. BVL is defined as follows:

$${L}_{BVL} ( x , y ) = \frac{1}{{N}_{b}} {\sum }_{j} {‖ {σ}^{2} ( {x}^{j} ) - {σ}^{2} ( {y}^{j} ) ‖}_{1} \qquad ( 4 )$$

Here, x^{j} is a vector containing samples of the j-th cell on a non-overlapping grid. The formula calculates the difference between the variances of the sample vectors in each block and computes the L I norm of the differences. The resulting value is then averaged over the total number of blocks, denoted as N_{b}.

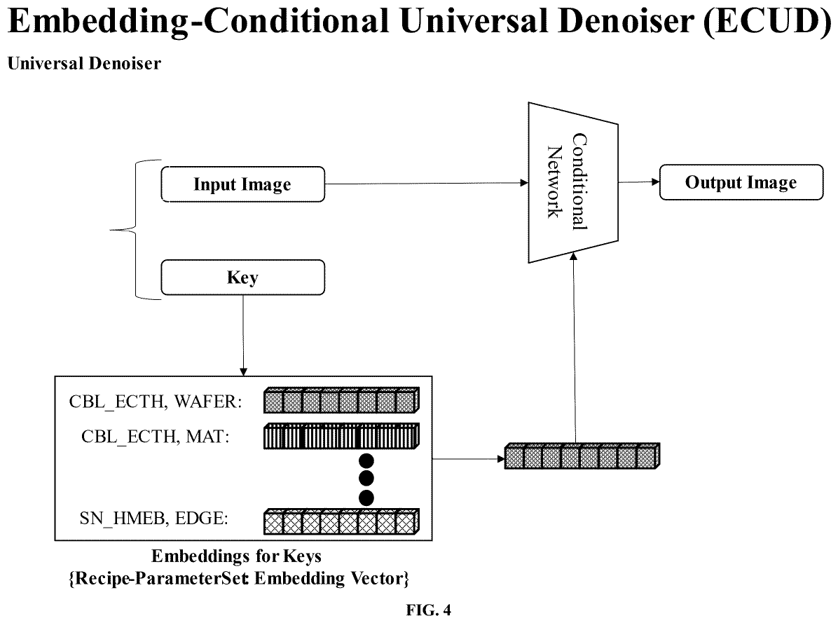

FIG. 4 shows an exemplary architecture of the universal denoiser, in accordance with some embodiments. One or more input images can be provided to the conditional network that can provide an output image (e.g., enhanced Ebeam image) that is enhanced from the one or more input images (e.g., base set of Ebeam images). A set of keys can be used to identify a set of conditions using embeddings for the keys. Once the appropriate embedding is identified, the condition network can use the embedding, which identifies the condition or conditions, to denoise the given image of a specific domain. For example, a domain or domain type such as an SEM may be associated with conditions or parameters, e.g., resolution or frame rate. Keys may be associated with and correlate to the conditions or parameters of the SEM to identify the SEM used for generating the base set of Ebeam images. Based on the keys, the universal denoiser may utilize a specific key for the specific SEM to enhance the set of Ebeam images from the base set of Ebeam images.

### Quality, Frame Rate Differences, and Throughput Performance

An objective of the present disclosure is to enhance the precision or accuracy of Ebeam-based metrology. Another objective is to reduce required sources (e.g., time, processes, measurements, and the like) of Ebeam-based metrology. Capturing a fewer number of frames can substantially shorten the imaging time but may result in reduced image quality. However, the disclosed universal denoiser can improve this reduced image quality by disclosing a technical solution herein for achieving high-quality Ebeam images.

In some embodiments, the enhanced set of Ebeam images comprises a greater number of frames than the base set of Ebeam images. In some embodiments, the number of frames is at least about 5%, 10%, 15%, or greater than the number of frames of the base set of Ebeam images. In some embodiments, the higher quality of the enhanced set of Ebeam images is based at least in part on the greater number of frames. In some cases, the higher quality can be a higher resolution. In some embodiments, the base set of Ebeam images comprises a limited or low number of frames. In some embodiments, the limited or low number of frames is at least about 15%, 10%. 5%, or lower than the enhanced set of Ebeam images.

In some embodiments, methods may use the enhanced set of Ebeam images for metrology within the process environment and obtain a metrology throughput improvement of at least 10% by applying the universal denoiser as compared to without applying the universal denoiser. In some embodiments, the metrology throughput improvement is at least 40%. Furthermore, the present disclosure can improve the acquisition time of Ebeam images and increase the accuracy of general computer vision techniques, which can lead to processing a larger number of images in a shorter period of time.

For example, Ebeam-based measurements can take several minutes, tens of minutes, or longer. Because Ebeam devices are expensive, even semiconductor companies usually have a limited number of SEMs. By incorporating the universal denoiser disclosed herein, a throughput improvement of at least 14% to 42% may be realized, which can depend on the recipe. This improvement in throughput can help increase production capacity. In some embodiments, the frame rate of the enhanced set of Ebeam images is at least about 8 frames per second, and the frame rate of the base set of Ebeam images is about 0.1 frames per second.

### Network Architectures for Universal Denoiser

In another aspect, disclosed herein is a network architecture for use in a universal denoiser system to enhance electron-beam (Ebeam) images, the network architecture comprising: a condition network configured to calculate a plurality of values using a condition embedding: a conditioned ResBlock configured to utilize at least some of the values to adjust an intermediate response map based at least in part on importance of the values; and a conditioned affine layer configured to (1) enable learning of EBeam image synthesis logic and (2) allow for application of different conditions to separately learn a suitable recipe for a particular EBeam process.

### Condition Network

The network architecture can include a condition network configured to implement the conditioning scheme, described elsewhere herein. In some embodiments, the plurality of values calculated by the condition network include alpha, beta, or gamma values, or combinations thereof. In some embodiments, the condition embedding is converted through a condition table. In some embodiments, the condition table is configured to convert input in a form of recipe metadata into the condition embedding. In some embodiments, the recipe metadata includes numerical and categorical conditions. In some embodiments, the condition table comprises an embedding table configured to embed the categorical conditions.

### Conditioned ResBlock

The network architecture can include the conditioned ResBlock, described elsewhere herein. In some embodiments, the at least some of the values utilized by the conditioned ResBlock include the beta and the gamma values. In some embodiments, the conditioned ResBlock comprises a conditioning block configured to adjust the intermediate response map by applying the beta and gamma values. In some embodiments, the intermediate response map is adjusted to emphasize or weaken one or more channels, based at least in part on a relevance of each of the one or more channels to the particular EBeam process.

### Conditioned Affine Layer

The network architecture can include the conditioned affine layer, described elsewhere herein. In some embodiments, the embedding table is learned via a training process using the conditioned affine layer. In some embodiments, the embedding of the categorical conditions is optimized to more accurately capture unique characteristics of input data, with progression in the learning of the embedding table. In some embodiments, the condition network is configured to effectively adjust features based at least in part on the recipe metadata and the conditioned affine layer, thereby enabling improvements in accuracy and precision in the enhanced set of Ebeam images.

### EXAMPLES

### Example 1: Testing and Validating with Data

Validation of the universal denoiser disclosed herein was performed on 27 recipes as shown in Table 1. Since alignment and metrology results can vary slightly depending on the image, the validation was performed on 17 stable recipes (rows 1-17). Table 1 also shows results for the remaining 10 recipes, which included 6 slightly unstable recipes (rows 18-23) and 4 unstable recipes (rows 24-27). All 17 stable recipes passed the validation test. In some cases, a “Pass” designation can mean that the root-square (RSQ) metric value between measurements from the 32F Ebeam images and the 8F denoised images exceeded 0.9. In some cases, the RSQ metric value can exceed 0.7, 0.8, 0.9, or greater.

TABLE 1

| | EVAL_CSASS | RECIPE_NAME | COMPARISON |
|---|---|---|---|
| 1 | CLASS 1 | SECRET_RECIPE_T01_I01 | All PASS |
| 2 | CLASS 1 | SECRET_RECIPE_T01_I02 | All PASS |
| 3 | CLASS 1 | SECRET_RECIPE_T02_I01 | All PASS |
| 4 | CLASS 1 | SECRET_RECIPE_T03_I02 | All PASS |
| 5 | CLASS 1 | SECRET_RECIPE_T03_I03 | All PASS |
| 6 | CLASS 1 | SECRET_RECIPE_T03_I04 | All PASS |
| 7 | CLASS 1 | SECRET_RECIPE_T03_I05 | All PASS |
| 8 | CLASS 1 | SECRET_RECIPE_T03_I01 | All PASS |
| 9 | CLASS 1 | SECRET_RECIPE_T03_I02 | All PASS |
| 10 | CLASS 1 | SECRET_RECIPE_T03_I03 | All PASS |
| 11 | CLASS 1 | SECRET_RECIPE_T03_I04 | All PASS |
| 12 | CLASS 1 | SECRET_RECIPE_T03_I05 | All PASS |
| 13 | CLASS 1 | SECRET_RECIPE_T03_I06 | All PASS |
| 14 | CLASS 1 | SECRET_RECIPE_T03_I07 | All PASS |
| 15 | CLASS 1 | SECRET_RECIPE_T03_I08 | All PASS |
| 16 | CLASS 1 | SECRET_RECIPE_T03_I09 | All PASS |
| 17 | CLASS 1 | SECRET_RECIPE_T03_I10 | All PASS |
| 18 | CLASS 2 | SECRET_RECIPE_T03_I11 | FAIL -> PASS |
| 19 | CLASS 2 | SECRET_RECIPE_T02_I06 | FAIL -> PASS |
| 20 | CLASS 2 | SECRET_RECIPE_T02_I07 | FAIL -> FAIL |
| 21 | CLASS 2 | SECRET_RECIPE_T02_I08 | FAIL -> PASS |
| 22 | CLASS 2 | SECRET_RECIPE_T02_I09 | FAIL -> FAIL |
| 23 | CLASS 2 | SECRET_RECIPE_T02_I10 | FAIL -> FAIL |
| 24 | CLASS 3 | SECRET_RECIPE_T03_I12 | PASS |
| 25 | CLASS 3 | SECRET_RECIPE_T03_I13 | NOT- |
| | | | EVALUATED |
| 26 | CLASS 3 | SECRET_RECIPE_T03_I14 | FAIL |
| 27 | CLASS 3 | SECRET_RECIPE_T03_I15 | FAIL |

In addition to testing and validating the 27 recipes shown in Table 1, Table 2 shows the performance validation of the universal denoiser model trained on only a subset of the recipes on unlearned recipes. The additional 9 recipes (rows 18-27) all passed the validation except for one recipe, which was excluded (row 22) due to an absence of a corresponding condition key.

TABLE 2

| | EVAL_CSASS | RECIPE_NAME | COMPARISON |
|---|---|---|---|
| 1 | CLASS 1 | SECRET_RECIPE_T01_I01 | IDENTICAL |
| | | | RESULT |
| 2 | CLASS 1 | SECRET_RECIPE_T01_I02 | IDENTICAL |
| | | | RESULT |
| 3 | CLASS 1 | SECRET_RECIPE_T02_I01 | IDENTICAL |
| | | | RESULT |
| 4 | CLASS 1 | SECRET_RECIPE_T03_I02 | IDENTICAL |
| | | | RESULT |
| 5 | CLASS 1 | SECRET_RECIPE_T03_I03 | IDENTICAL |
| | | | RESULT |
| 6 | CLASS 1 | SECRET_RECIPE_T03_I04 | IDENTICAL |
| | | | RESULT |
| 7 | CLASS 1 | SECRET_RECIPE_T03_I05 | IDENTICAL |
| | | | RESULT |
| 8 | CLASS 1 | SECRET_RECIPE_T03_I01 | IDENTICAL |
| | | | RESULT |
| 9 | CLASS 1 | SECRET_RECIPE_T03_I02 | IDENTICAL |
| | | | RESULT |
| 10 | CLASS 1 | SECRET_RECIPE_T03_I03 | IDENTICAL |
| | | | RESULT |
| 11 | CLASS 1 | SECRET_RECIPE_T03_I04 | IDENTICAL |
| | | | RESULT |
| 12 | CLASS 1 | SECRET_RECIPE_T03_I05 | IDENTICAL |
| | | | RESULT |
| 13 | CLASS 1 | SECRET_RECIPE_T03_I06 | IDENTICAL |
| | | | RESULT |
| 14 | CLASS 1 | SECRET_RECIPE_T03_I07 | IDENTICAL |
| | | | RESULT |
| 15 | CLASS 1 | SECRET_RECIPE_T03_I08 | IDENTICAL |
| | | | RESULT |
| 16 | CLASS 1 | SECRET_RECIPE_T03_I09 | IDENTICAL |
| | | | RESULT |
| 17 | CLASS 1 | SECRET_RECIPE_T03_I10 | IDENTICAL |
| | | | RESULT |
| 18 | CLASS 2 | SECRET_RECIPE_T03_I11 | IDENTICAL |
| | | | RESULT |
| 19 | CLASS 2 | SECRET_RECIPE_T02_I06 | IDENTICAL |
| | | | RESULT |
| 20 | CLASS 2 | SECRET_RECIPE_T02_I07 | IDENTICAL |
| | | | RESULT |
| 21 | CLASS 2 | SECRET_RECIPE_T02_I08 | IDENTICAL |
| | | | RESULT |
| 22 | CLASS 2 | SECRET_RECIPE_T02_I09 | NO MATCHED |
| | | | DB RECIPE |
| 23 | CLASS 2 | SECRET_RECIPE_T02_I10 | IDENTICAL |
| | | | RESULT |
| 24 | CLASS 3 | SECRET_RECIPE_T03_I12 | IDENTICAL |
| | | | RESULT |
| 25 | CLASS 3 | SECRET_RECIPE_T03_I13 | IDENTICAL |
| | | | RESULT |
| 26 | CLASS 3 | SECRET_RECIPE_T03_I14 | IDENTICAL |
| | | | RESULT |
| 27 | CLASS 3 | SECRET_RECIPE_T03_I15 | IDENTICAL |
| | | | RESULT |

Furthermore, initial experimental results show that more data and conditioning can be effective to further improve the precision and accuracy of metrology. For example, a comparison of the critical dimension (CD) values measured from a 32F Ebeam image are provided in Table 3, with the CDs obtained from various sources. For example, a sample set of an 8F-Raw Ebeam image without a denoiser had a root-square (RSQ) metric of 0.908 and a root-mean-square error (RMSE) metric of 0.938 (row 1). An image derived from a model trained on a target dataset (e.g., target only) had an RSQ of 0.930 and an RMSE of 0.637 (row 2). An image obtained from a model trained on all data had an RSQ of 0.940 and an RMSE of 0.440 (row 3). An image obtained from a model trained on all data plus a conditioning network of the present disclosure had a RSQ of 0.942 and 0.946, respectively, and an RMSE of 0.392 and 0.390, respectively (rows 4 and 5). In some cases, the universal denoiser improves RSQ by at least about 4.2% over a method that does not user a denoiser. In some cases, the universal denoiser improves RMSE by at least about 58% over a method that does not user a denoiser.

TABLE 3

| Training | | | Improvement | | Improvement |
|---|---|---|---|---|---|
| Method | Denoiser | RSQ | Over 1 | RMSE | Over 1 |
| 1 | No denoiser | 0.908 | — | 0.938 | — |
| 2 | Trained on a | 0.930 | 2.4% | 0.637 | 32.1% |
| | target dataset | | | | |
| 3 | Trained on | 0.940 | 3.5% | 0.440 | 53.1% |
| | all data | | | | |
| 4 | Trained on | 0.942 | 3.7% | 0.392 | 58.2% |
| | all data | | | | |
| 5 | Trained on | 0.946 | 4.2% | 0.390 | 58.4% |
| | all data with | | | | |
| | conditioning | | | | |
| | network | | | | |

### Terms and Definitions

Unless otherwise defined, all technical terms used herein have the same meaning as commonly understood by one of ordinary skill in the art to which this disclosure belongs.

As used herein, the singular forms “a.” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%. 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Machine Learning

In some embodiments, machine learning algorithms are utilized to aid in denoising Ebeam images. In some embodiments, the machine learning algorithm is used to generate or predict a suitable process or recipe for improving Ebeam images. In some embodiments, machine learning algorithms are utilized by the condition network or the conditioned ResBlock to transform the feature or intermediate response map. In some embodiments, the machine learning algorithms may employ one or more forms of labels including but not limited to human annotated labels and semi-supervised labels. The human annotated labels can be provided by users, e.g., process engineers and the like. The semi-supervised labels can employ a XGBoost, a neural network, or both.

Examples of machine learning algorithms can include a support vector machine (SVM), a naïve Bayes classification, a random forest, a neural network, deep learning, or other supervised learning algorithm or unsupervised learning algorithm for classification and regression. The machine learning algorithms can be trained using one or more training datasets.

In some embodiments, a machine learning algorithm is used to generate or recommend a recipe associated with Ebeam metrology to improve Ebeam images. A non-limiting example of a multi-variate linear regression model algorithm is seen below: probability=A₀+A₁(X₁)+A₂(X₂)+A₃(X₃)+A₄(X₄)+A₅(X₅)+A₆(X₆)+A₇(X₇) . . . wherein Aᵢ (A₁, A₂, A₃, A₄, A₅, A₆, A₇, . . . ) are “weights” or coefficients found during the regression modeling; and Xᵢ (X₁, X₂, X₃, X₄, X₅, X₆, X₇, . . . ) are data collected from the User. Any number of Aᵢ and Xᵢ variable can be included in the universal denoiser model

### Computing System

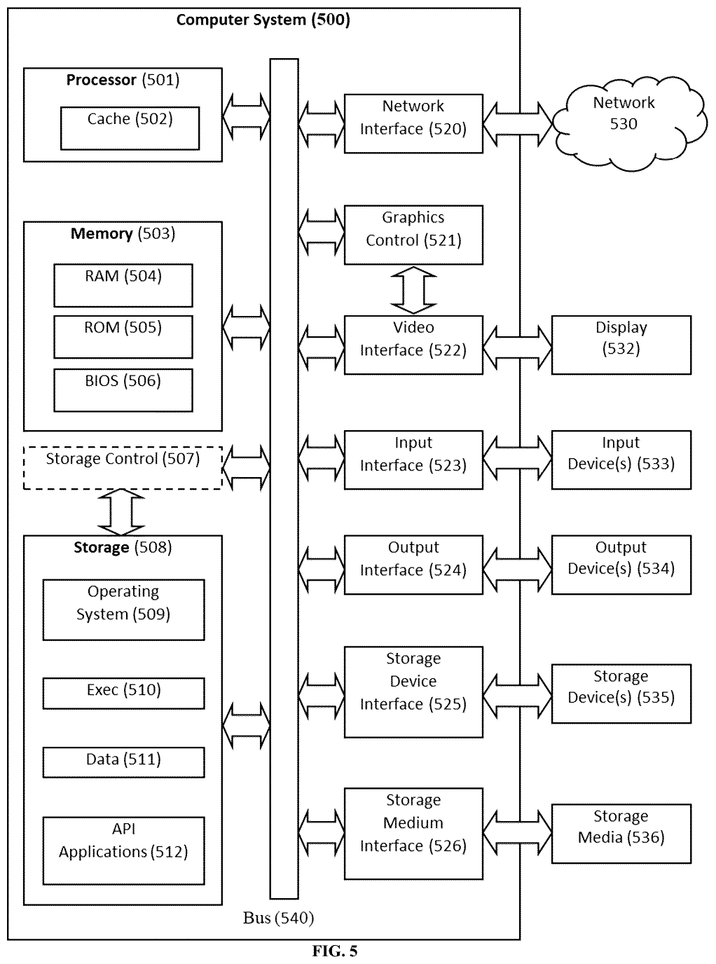

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs) or general-purpose graphics processing units (GPGPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 536. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect. Leap Motion, or the like. Input device(s) 533 may be interfaced to bus 540 via any of a variety of input interfaces 523 (e.g., input interface 523) including, but not limited to, serial, parallel, game port. USB, FIREWIRE. THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display 532. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In some embodiments, the display is a video projector. In some embodiments, the display is a head-mounted display (HMD) such as a VR headset. In further embodiments, suitable VR headsets include, by way of non-limiting examples, HTC Vive. Oculus Rift. Samsung Gear VR. Microsoft HoloLens. Razer OSVR, FOVE VR, Zeiss VR One, Avegant Glyph, Freefly VR headset, and the like. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers. Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples. Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples. Sony® PS3®, Sony® PS4®, Microsoft® Xbox 360®, Microsoft Xbox® One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects. Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples. Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML). Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX). Flash® Actionscript. Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM Lotus Domino®. In some embodiments, a web application includes a media player element. In various further embodiments, a media player element utilizes one or more of many suitable multimedia technologies including, by way of non-limiting examples, Adobe® Flash®, HTML 5. Apple® QuickTime®, Microsoft® Silverlight®, Java™, and Unity®.

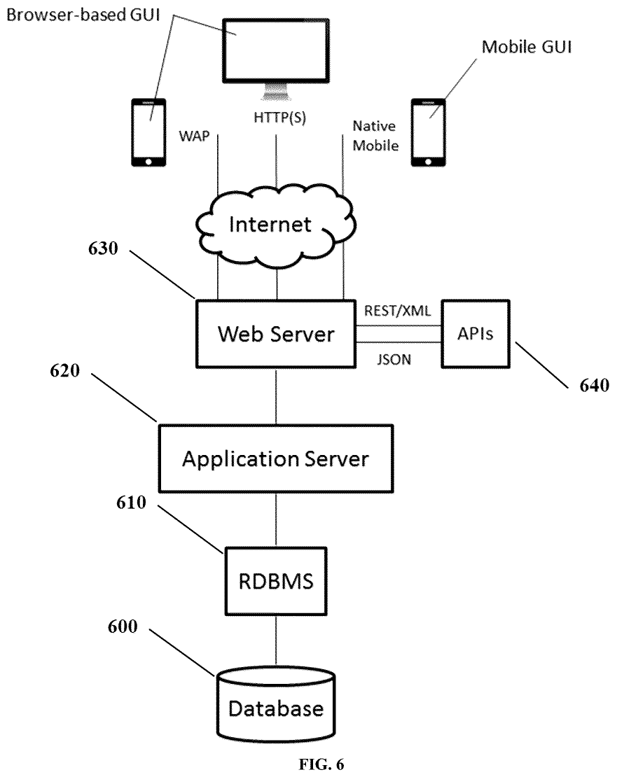

Referring to FIG. 6, in a particular embodiment, an application provision system comprises one or more databases 600 accessed by a relational database management system (RDBMS) 610. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 620) (such as Java servers, .NET servers, PHP servers, and the like) and one or more web servers 630 (such as Apache, IIS, GWS and the like). The web server(s) optionally expose one or more web services via app application programming interfaces (APIs) 640. Via a network, such as the Internet, the system provides browser-based and/or mobile native user interfaces.

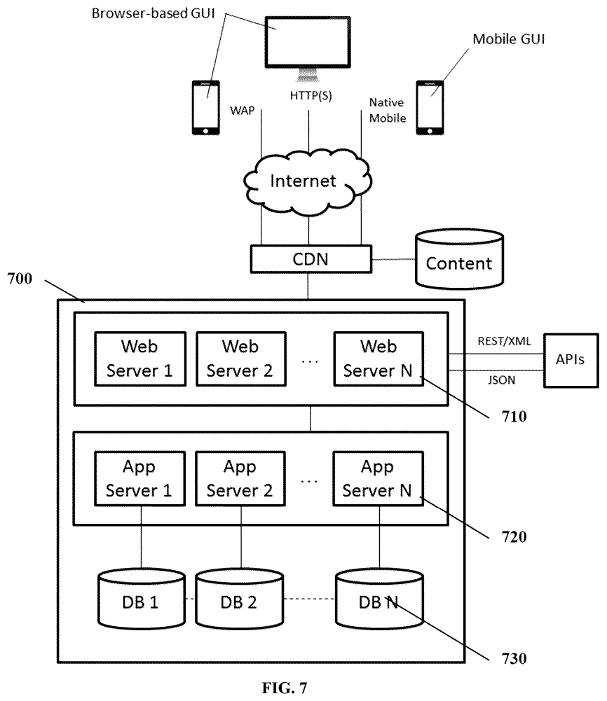

Referring to FIG. 7, in a particular embodiment, an application provision system alternatively has a distributed, cloud-based architecture 700 and comprises elastically load balanced, auto-scaling web server resources 710 and application server resources 720 as well synchronously replicated databases 730.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of metrology information. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that systems, methods and structures within the scope of these claims and their equivalents be covered thereby.

1.-36. (canceled)

37. A method of enhancing electron-beam (Ebeam) images, comprising:
obtaining a base set of Ebeam images from a plurality of domains within a process environment; and
applying a universal denoiser to the base set of Ebeam images to generate an enhanced set of Ebeam images, wherein the enhanced set of Ebeam images has a higher quality than the base set of Ebeam images and accounts for a domain type of each of the plurality of domains.

38. The method of claim 37, wherein the process environment comprises a semiconductor manufacturing environment.

39. The method of claim 37, further comprising using the enhanced set of Ebeam images for metrology within the process environment.

40. The method of claim 39, wherein the metrology comprises a measurement of one or more critical dimensions (CDs) in an intermediate output device or a final output device of the process environment.

41. The method of claim 40, wherein the intermediate output device or the final output device of the process environment comprises a deposited structure or a fabricated structure, and wherein the deposited structure or the fabricated structure comprises a film, a layer, or a substrate.

42. The method of claim 39, wherein the universal denoiser maintains a same set of measurands in the metrology across the plurality of domains within the process environment.

43. The method of claim 37, wherein the enhanced set of Ebeam images comprises a greater number of frames than the base set of Ebeam images.

44. The method of claim 43, wherein the greater number of frames is at least about 5%, 10%, 15%, or greater than the number of frames of the base set of Ebeam images.

45. The method of claim 43, wherein the higher quality of the enhanced set of Ebeam images is based at least in part on the greater number of frames.

46. The method of claim 37, wherein the base set of Ebeam images comprises a limited or low number of frames of at least about 15%, 10%, 5%, or lower than the enhanced set of Ebeam images.

47. The method of claim 37, wherein the plurality of domains is associated with a plurality of processing steps and/or a plurality of equipment in the process environment.

48. The method of claim 37, wherein the plurality of domains is associated with a plurality of Ebeam equipment, and wherein the domain type for each of the plurality of domains is associated with a type of Ebeam equipment.

49. The method of claim 48, wherein the type of Ebeam equipment comprises a transmission electron microscope (TEM), a scanning electron microscope (SEM), a reflection electron microscope (REM) lithography system, an electron beam inspection system, a focused ion beam system, or any derivatives or combinations thereof.

50. The method of claim 37, wherein the universal denoiser compensates for a range of noise types in the base set of Ebeam images and/or the enhanced set of EBeam images using at least in part a conditioning scheme, wherein the range of noise types is attributable to operating differences across the plurality of domains within the process environment.

51. The method of claim 37, wherein the domain type for each of the plurality of domains comprises one or more conditions associated with Ebeam generation for each of the plurality of domains, and wherein the one or more conditions comprise camera types and image capture parameters.

52. The method of claim 51, wherein the image capture parameters comprise image capture resolution and/or frame rate.

53. The method of claim 51, wherein the one or more conditions associated with the Ebeam generation for each of the plurality of domains are encoded into an image condition vector for each of the plurality of domains.

54. The method of claim 53, wherein the image condition vector for each of the plurality of domains is associated with a base subset of Ebeam images from each of the plurality of domains.

55. The method of claim 40, wherein the universal denoiser uses a plurality of loss functions to reduce differences in the metrology at a global level and to focus the metrology at a local feature level for the measurement of the one or more CDs.

56. The method of claim 55, wherein the plurality of loss functions is selected from the group consisting of metrology-aware marginal intensity loss (MMIL), noise level loss (NLL), threshold loss (THL), and block variance loss (BVL).
